(19) United States
(12) Patent Application Publication
(10) Pub. No.: US 2010/0094731 A1
(43) Pub. Date: Apr. 15, 2010

(54) SECURITY SYSTEM AND METHOD FOR INTEGRAL TRACEABILITY AND TRACKING

(76) Inventors: Annibale Raimondo, Caserta (IT); Franco Staino, Roma (IT)

Correspondence Address: Steinfl & Bruno, 301 N Lake Ave Ste 810, Pasadena, CA, 91101, US

(21) Appl. No.: 12/446,843

(22) PCT Filed: Aug. 9, 2007
(86) PCT No.: PCT/IB07/53159

§ 371 Date: Nov. 23, 2009

(30) Foreign Application Priority Data
Oct. 26, 2006 (IT) RM2006A000580

(51) Int. Cl. G06Q 10/00; G06F 17/30

(52) U.S. Cl. 705/28; 707/690; 707/E17.005

(57) ABSTRACT

A safety system for integral traceability and tracking is described. The system singles out products as sooon as they are identified and coded, along their entire shelf life.

The present invention refers to a safety system for integral traceability and tracking capable of assuring the certain singling out of the product from when it is identified and coded, along its entire shelf life (down to the final use or destruction thereof) against counterfeiting practices, therefore making implicit therein all of the certifications possessed by the producer of the same good.

Today, the issue of product traceability and tracking is ever more felt in any field of marketable goods.

In the agro-industrial field, current systems go no further than traceability capable of assuring the tracking, and not the ‘integral safety’ of the product originality. For this purpose, an ever greater number of businesses in the agro-industrial section have equipped themselves with systems for internal tracking, or anyhow referring to the part of production chain within their competence; yet there is a need, and there will be ever more and with urgency, to document the entire agro-industrial chain from the producer to the consumer, from contribution (pooling) to processing/transformation, to the sale.

In fact, it is known that specific laws are being developed to control by regulation such processes. For instance, the European Union, by approval of EC Regulation 178 of 28 Jan. 2002, makes agro-industrial traceability mandatory from 1 Jan. 2005, defining it as the ability to trace (reconstruct) and follow the movement of a food, feed, food-producing animal, or substance intended to be or apt to be incorporated into a food or feed through all stages of production, processing and distribution. In Italy, UNI Standard 10939: 2001 defines traceability as the ability to reconstruct the history of a product and of its transformations, with documental information. Actually, for the producer it is a batch-administering function, whereas for the consumer it remains a mere advertising reference, scarcely reliable and anyhow not objectively and independently certifying. Relevant regulations: White Book on food safety; EC Regulation 178/2002; Legislative Decree Nr. 228/2001; Legislative Decree Nr. 155/97. Voluntary regulations: Standards UNI 109397 and 11020; ISO 22000.

GS1 (UNICOD-ECR) is the product coding system most widespread in the field of consumer goods worldwide. This system enables businesses to univocally identify trade units, logistic units, services, places and functions worldwide, by using identification (ID) numbers, in the form of bar symbols that may be read electronically. Today, subscribing organizations are 101, in 103 nations on all continents and with about 1,000,000 associated businesses, witnessing GS1 universality. Aim of the GS1 system is to provide a standard language at international level through bar codes and symbols (EAN-13; EAN-8; ITF-14; GS1-128), preventing the proliferation of proprietary systems varying from country to country, and even inside an individual country. GS1 system is ‘bijective’: each trade unit (consumer unit, packaging unit or logistic unit) is identified by a single code and to each code there corresponds a single trade unit, in all countries of the GS1 circuit. The bar code enables optical readers, placed at the counters of the points of sale, to automatically record outgoing products (brand, type, price) automatically writing them down from warehouse accounting and providing a detailed expense bill to the individual purchaser. GS1 system is an irreplaceable tool for increasing the effectiveness of the production-distribution-consumption cycle, in terms of effectiveness and cost reduction. It allows, e.g., to:
eliminate price marking on the single product;
have analytical availability of sales per product;
carry out optimum stocking and restocking;
reorder within the time-limits;
carry out control and analysis of sale promotions;
analyze individual profits;
have permanent inventory and automatic accounting;
avail oneself of returned goods and inventory analysis;
trace movements of goods along the distribution chain.

However, the GS1 system does not specifically deal with safety integral traceability and tracking aimed to producer, distributor and consumer protection, but only defines technical specifications at an international level. The national coding organizations present in each country (INDICOD-ECR in Italy) are in charge of the assigning of reference nation codes and of the compliance with rules at a national level.

A further example may be found in the ‘Drug Traceability Project’ (designed by IPZS/ARES), providing the establishment of a Data Bank managed by the Italian Ministry of Health, aimed to the control of the codes associated to drugs (by the applying of ID media printed on water-marked paper provided with security systems) and issued by the Data Bank of the State Printing Office and State Mint into the distribution system. In these terms, the project might appear as a purely technical activity of mere statistic and bureaucratic interest. Actually, the project is far more wide-ranging, lies within the context of the enforcement of EC laws and comprises aspects and aims of great interest to public health. In fact, by Article 40 of Italian Law of 1 Mar. 2002, Nr. 39, on the “Provisions for compliance with obligations deriving from Italy's belonging to European Communities, Community Law 2001”, through which Article 5-bis in legislative decree of 30 Dec. 2002, Nr. 540 intervenes, it is envisaged just the establishing, at the Ministry of Health, of a data bank that, from the production and supply data of numbered stamps for drugs, shall collect and record the movements of the individual packaging of medicinal products.

The aims of this system for tracking medicinal products are not limited to the reinforcement of the measures for opposing possible frauds to the detriment of public health, of the National Health System and the national revenue, but also comprise the prevention and the suppression of any illegal activity and the monitoring of drug supplies, both in hospitals, in territorial pharmacies and other authorized centres, and for direct distribution. This monitoring, just owing to the different interpretations it offers, prefigures a relevant cultural project. In fact, the option of following drug packaging in the distribution channel will enable to ‘translate’ the monitoring of the drug offer on the national territory into precious epidemiological information on the patterns of the most relevant pathologies, allowing to take decisions on the investments required for preparing measures suitable in the case at issue. Moreover, it will be possible to make the national drug control program more effective, and, in perspective, promote appropriateness of prescription and consumption, by the subsequent direct connection between drug packaging, the prescriber and the citizen. However, the teachings in literature leave still open the following problem: actually, in the adopted solutions, no securized element is created that certifies the originality of the product arrived to the consumer, including the correct distribution thereof in centres authorized to this function.

The ‘Drug Traceability Project’—set up, as mentioned above, by ARES and IPZS—in the version used by the Ministry of Health fails to solve in its set-up the fundamental aspects represented by the unitarity of the moments of ID code generation, management and monitoring, as well as the essential one of certification of the entire process by a third body.

Object of the present invention is to overcome the drawbacks mentioned above with reference to the known art, by providing a method for integral traceability and tracking of a plurality of products from their being inletted into a distribution chain (cycle) to their exiting the same chain, through any movement thereof, as defined in claim 1.

A further, object of the present invention is to provide a system for integral traceability and tracking of a plurality of products from their being inletted into a distribution chain (cycle) to their exiting the same chain, through any movement thereof, as defined in independent claim 9.

Secondary features of the present invention, are instead defined in the corresponding dependent claims.

The present invention, by overcoming the mentioned problems of the known art, entails several evident advantages.

First of all, the present invention provides an integral safety instrument capable of assuring some fundamental elements, such as:
certainty of the correspondence of product with that marketed by the producer or importer;
certainty that the product has followed a correct and law-regulated distribution circuit, and that therefore the former has not been subjected to a temporary exiting the latter;
certainty that the product has been subjected, at each stage, to the tax treatment in force.

In addition, the system, in its plural applications and depending on the specific typology of medium used, is capable of providing all information related to the life of the product, from production to final consumption.

Object of the present invention is a unified system managed on a worldwide information network, capable of correlating and facing all issues of integral traceability and trackability and safety, regardless of the goods typology of the marketed products.

On the one hand, the invention solves the fundamental problem of assuring to the consumer the originality of the product object of consumption; on the other hand, the invention is capable of bringing back all information to a single system for examination and control, capable of correlating them thereamong. To put it differently, the invention certifies the producer's direct guarantee to distribution and consumers, which is enacted through the recording and transmitting of the retailer's ID code to the Management and Control Centre, as it will be better detailed hereinafter.

Other relevant implicit advantages are the following:
the system offers to all marketed consumer goods, in any Country of the world that has decided to adopt the System at issue, the integral and safety traceability and tracking capable of assuring the originality of the product, or of finding out counterfeit products;
with the system subject-matter of the invention—through the production, the delivery to the producer and the association to any marketed packaging, suitably certified by the international network in charge—all products are identified, in the different steps, with automatic, systematic and anyhow mandatory transmissions of information by means of the service Central Data Bank network. With this system setting, there is a checking of marketed goods with the implicit transparence of which are actually the original products;
certainty of tax treatment of marketed goods flows in all distribution steps.

Further advantages, features and operation modes of the present invention will be made apparent in the following detailed description of an embodiment thereof, given by way of example and not for limitative purposes. Reference will be made to the annexed figures, wherein:

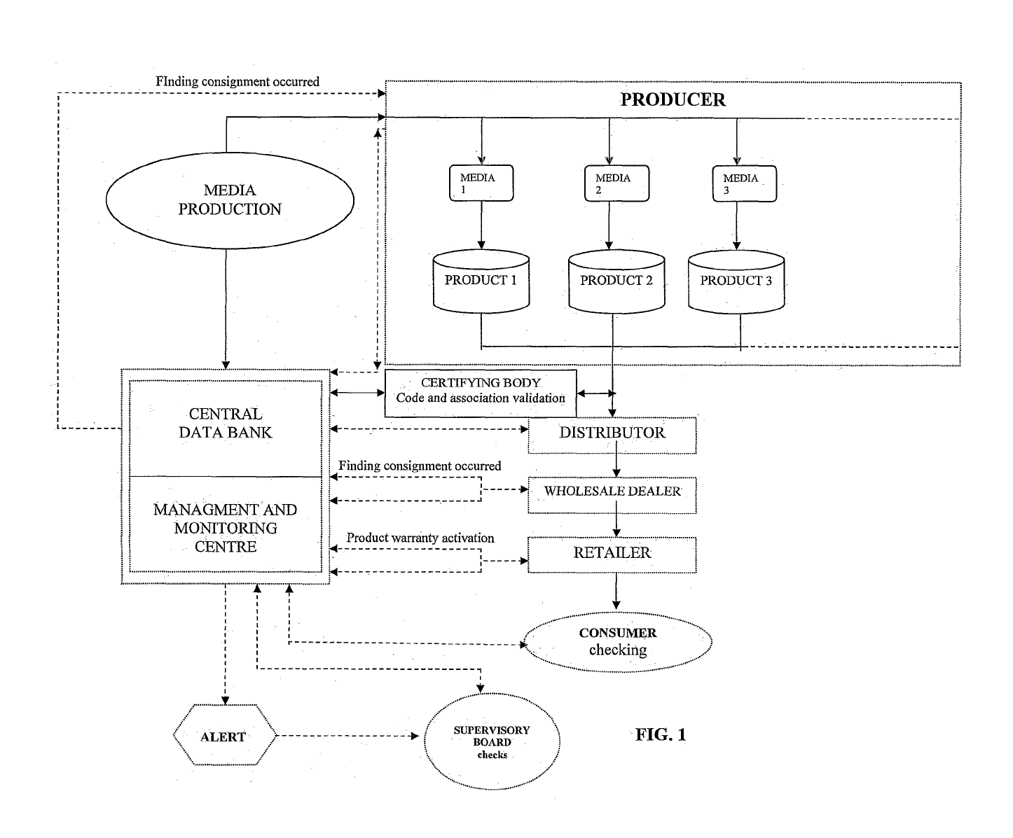

FIG. 1 is a block diagram of the system according to the present invention, apt to illustrate by way of example the main stages of the method according to the present invention; and

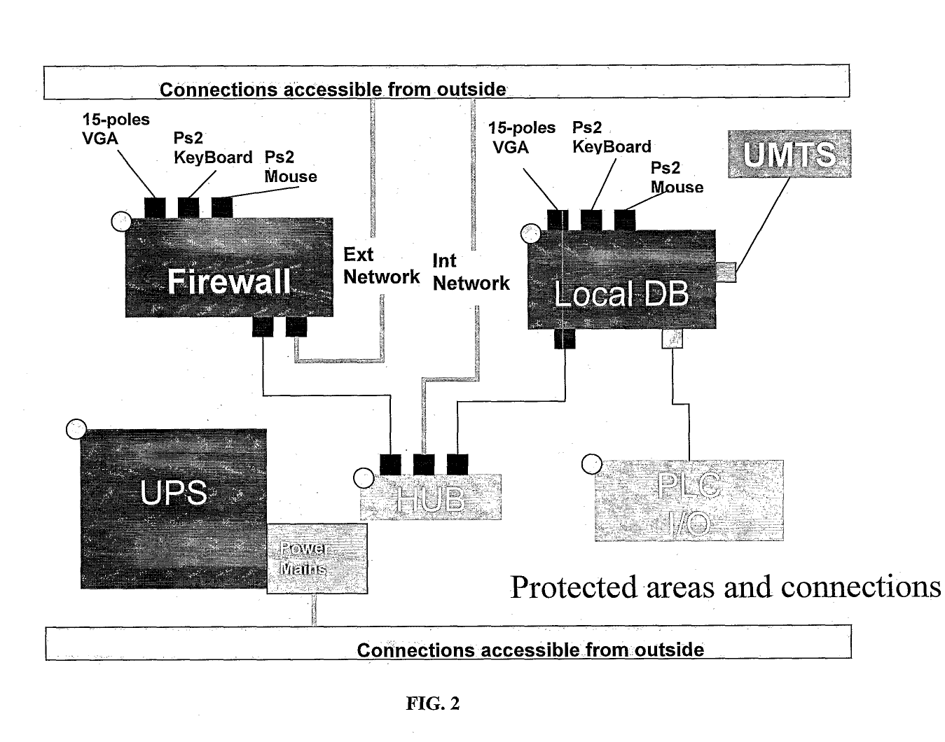

FIG. 2 is a block diagram of a peripheral unit according to the present invention.

The present invention will hereinafter be described making reference to the above-indicated figures.

The present invention is proposed as solution for controlling the quality of production and supply chain cycles for consumer goods and technological products intended for inland or international market of individual States or for internal use of individual firms or groups of the same.

In particular, the present invention is aimed to a method for integral traceability and tracking of a plurality of products, from their being inletted into a distribution chain to their exiting the same chain, through any movement thereof, providing the association of a single and univocally determined code to each product that is to be controlled.

More specifically, the codes are generated by a Management and Monitoring Centre that manages and controls a Central Data Bank.

The codes are provided from the Management and Monitoring Centre to the producers subscribing to the system, upon validation and certification by a Certifying Body. Therefore, depending on the medium provided, codes are definitively and univocally associated with a corresponding product to be inlet in the distribution process.

Specifically, the Central Data Bank sends and receives the significant data by means of peripheral units UP located directly at the connected sites. Said units are essential to improve the safety of the entire system, since data transmission between these units and the Data Bank or the Certifying Body will take place through use of proprietary protocols that will never be documented to third parties. In practice, the Data Bank extends to the sites connected through these peripheral units.

An exemplary block diagram of one of said peripheral units is shown in FIG. 2. Said units will be protected by anti-intrusion and antitampering systems providing, among other things a connection to the Data Bank even through the GSM network in order to assure transmission of alerting signals even in case Internet connecting cables are cut off.

Each peripheral unit UP of the system is practically the extension of the Central System, formed by the Data Bank and the Certifying Body, down to the end user's premises.

Its main function is to assure, beyond what is already possible thanks to VPN (Virtual Private Network) use, all data transmission operations to and fro the Central System. For this reason, it is equipped with a whole set of sensors preventing access to internal processing units.

The safety provided by this device is mainly linked to the fact that the transmission protocols between it and the Central System and all that concerns data transmission needs not be disclosed to anyone, not even to the end user, as it is directly managed from the UP itself.

Thus, the broadest guarantees may be provided on the transmission, the use and the storage of all data that are essential to the correct operation of the system, and in particular of the codes generated and subsequently used by this system.

Then, the entire distribution process is certified by an international network (Certifying Body) in charge of controlling the cycle.

Preferably, physical media are used, better described hereinafter, each bearing one or more of said codes. Then, the ‘identified media’ are definitively associated with and applied or impressed, melt, sandblasted, etc., to the products.

Concomitantly, the assigned codes remain stored, along with any other information useful to the identification of the products with which they are associated, in the Central Data Bank, monitored by the Management and Monitoring Centre.

The Management and Monitoring Centre, to which the Central Data Bank is associated, is apt to generate and store the data related to the products to be controlled, and in particular to their respective ID codes.

Of course, the system according to the present invention provides means for storing data on the Central Data Bank. Such means, both hardware and software ones, is to be deemed within the reach of a person skilled in the art, and therefore will not be detailed hereinafter.

Subsequently to production, any movement of any individual product, and any transit thereof from one level to another of the distribution process, should be recorded and stored on the Central Data Bank, always exclusively making reference to the ID code of the product itself.

In particular, on the Central Data Bank there should be, recorded all those steps envisaging the product exiting the monitoring cycle, e.g. the sale to the final consumer, the destruction, the theft, or other. At this stage, the corresponding codes are frozen into a list of invalidated bar codes that cannot be used anymore.

Moreover, the system is equipped with means, typically of software type, for checking the consistency of the data stored on the Central Data Bank.

In particular, the Management and Monitoring Centre, by querying the Central Data Bank; ascertains that the codes of the media of the exchanged goods are consistent, i.e. not corresponding to codes:
duplicated from others on the market;

duplicated from others already out of the market;
not matching issued series.

From inconsistencies found out, there stem the assessments, through the activation of suitable alerts and/or signaling, aimed to highlight fraudulent actions.

This is possible because all codes associated with circulating products have been generated by the system itself and validated by a Certifying Body, internal to the system. Moreover, the system is informed of each product exiting the distribution process. Therefore, e.g. for putative counterfeiters, it is not possible to inlet into the distribution process counterfeit products bearing fake ID codes, because the latter, not having been validated by the Certifying. Body, would not be recognized by the Management and Monitoring Centre.

Moreover, the system provides means for invalidating those codes for which a movement is stored which corresponds to the product exiting the distribution chain.

These codes are entered into a list of invalidated codes that cannot be used anymore. Such a list can therefore be used during the above-mentioned consistency checking. Evidently, the Management and Monitoring Centre may advantageously be queried also by Authorities and/or Bodies external to the system, in order to allow checks and/or controls on the production and distribution cycles, e.g. by the judicial authority.

In particular, it is a system apt to set up, customize, propose and manage different applications, depending on the products, the various configurations and the most varied needs of the markets.

The different viable applications, always adopted to assure safety traceability and tracking, are based on an information and relational network capable of monitoring and assessing all movements of the product on the market. This network has a perimeter that, as such, sets the limits thereof.

In order to have value as guarantee and validation, and not of mere numbering as is the case today, the adopted identifying media should warrant, besides inviolability, also non-replicability, therefore the inletting of counterfeit products into the market and the ability to single out the same by consumers, distributors and police.

The system is completed with the establishing, within its own scope, of a network comprised of technical subjects and certifying authorities of international reliability, recognized at worldwide level. The guaranteeing and certifying network sees to the management of a data bank, to the guarantee both of the certainty and the preservation of the same, giving to the product the standard of ‘sole and irreplaceable’.

The system is universal and therefore directly useful in all different economic macroareas:

a) Developed countries (e.g.: USA, EU, Japan) for which the increasing need of safety traceability and tracking systems—actually being a real monitoring of the product at each distribution stage—is accompanied by a capability of application flexibility;
b) Countries with a marked growth (e.g.: China, India, Korea) for which the needs to introduce safety traceability and tracking systems is accompanied by the need of systems for international validation, which becomes an actual market-propelling element.

The packaging are univocally identified by the sole medium reported thereon or on the product itself, bearing the ID code of the packaging itself and the sequence number code.

Referring to the above-mentioned packaging, the following information should preferably be transmitted:
movements, along the distribution chain, of the packaging that has exited the distribution channel (e.g., by destruction, theft, disposal, export, etc.) destruction or theft thereof prior to their affixing onto the packaging;
destruction during the production process (scraps);
return to media producer.

All information related to the movements of the products subjected to trading transaction and to those that have exited the packaging and media distribution channel should be transmitted to the Central Data Bank according to a predefined format.

The invention enables the correct registration and transmission to the Central Data Bank of the data of the steps in the distribution chain, and in particular from the retailer to the consumer, to be the essential point to activate the product warranty and therefore the producer's liability.

To enable several different subjects to correctly feed the Central Data Bank, there becomes necessary the use of a homogeneous language, through which there may univocally be identified, besides the packaging subjected to movements, the logistic sites to which such movements are referred.

An advantage entailed in the use of these peripheral units lies in the fact that the installations at the end user of all connection systems could be reduced to the mere sending of the unit itself to the same client, who should just connect the network (Internet and LAN) cables and the power supply. All the rest would be done automatically. The peripheral unit would automatically connect to the Central System, carry out all required effectiveness checks, tests and inspections, and get ready for the operation stage.

In practice, the peripheral unit, though based on a PC-like technology, has no need of being equipped with any kind of access, such as keyboard, mouse, etc., nor of a display to interface an operator, who is not required but at a maintenance stage. It has no exit to the outside world, save that for the Internet network and that for the internal LAN, in addition to the obvious connection to the power-supply mains.

It is totally, sealed by means of alerted ports, sending different alerting signals to the central, depending on the type of alert found. It is also equipped with a connection to the Internet network by means of GPS or GPRS or other analogous technologies, activated in case standard connections are interrupted.

The hardware structure is sufficiently redundant—twin CPUs connecting twin HDs, etc.—to assure operation even in case of sudden failures of one or more component parts, and of course it is assisted by an uninterruptible power supply (UPS) intervening in case of power line drop.

In fact, for identification of the sender and receiver subjects (system users and utilizers) there have to be used the univocal ID codes generated and made available by the system.

Identification of senders and receivers with a system-assigned code:
Producer of marketed goods;
Primary distributor or depositary;
Intermediate distributor or wholesale dealer;
Final distributor or retailer;
Waste disposal centre.

The safety system for integral traceability and tracking according to the present invention relates to all technological products and consumer goods marketed by those subscribing to the system itself.

In particular, the conditions that should concomitantly occur in order to inlet each single product into the system may be summed up as follows:
the packaging should be equipped with an ID code according to system specifications;
the packaging should have completed the production process (end product);
the packaging should be inletted into the distribution channel.

Concerning specific data related to the subject-matter of the transmission, there have to be considered the possible case histories envisaged, for which an investigation is reported hereinafter.

Such case histories have been grouped within the following process contexts:
media production and inletting into the production chain;
packaging production;
association of identifying media to the product or packaging;
distribution;
warranty activation and therefore possibility to refer to producer's liability;
exiting the distribution channel.

For each case history found within the indicated contexts, it is reported a description of the file processing modes by:
figures, depicting the movements of packaging or media, where present;
tables, describing for each typology of information to be transmitted the subject to which falls the responsibility of transmitting, the record plot, the description to be used and other information useful for preparing the files to be transmitted.

Referring to the media, the information transmitted from media production and distribution chain and inletted to the Central Data Bank are:
movements output from media producers and production/product packaging factories;
media returns by production factories;
events that media may undergo prior to being inletted into the product packaging process (e.g. destructions, thefts, losses, etc.).

Referring to the packaging production process, subject to mandatory transmission to the Central Data Bank are the information related to media destroyed during the former, defined as production scraps.

Transmission of production scrap-related data to the Central Data Bank, though managed by the peripheral units, should be performed with a preset frequence; anyhow, transmission should be performed within the production end date of each production batch.

For the management of transmissions referring to sales of medicinal product packaging, the following typologies of distinct causes are envisaged:
the cause National Sale of production, for all supplies to in-Country logistic sites;
the cause Sale Abroad, for product exports.

From a logical standpoint, returning corresponds to a movement of packaging that returns from the original receiver of the goods to the sender, going back along the production chain.

Returning occurs in correspondence with:
errors in the supply;
returns to supplier;
returning from customer.

Therefore, each movement due to returning derives from a preceding movement due to distribution between two juridical subjects.

In case of returning of packaging corresponding to supplies, the related economical values should be transmitted in one of the following alternative modes:
valorization of the field with which there are transmitted the information related to movements due to returning at the inletting and return to supplier from distribution for account. In that case, transmission of returning values is punctual with respect to each receiver;
transmission aggregated by packaging typology, through a file in which the value of returned packaging should be deducted from the total value of supplies in the month in which the movement by returning takes place. In that case, transmission of returning-related information occurs monthly and it is not punctual for the receiver.

In case of returns due to replacements, it is necessary to perform two transmissions: one related to the customer-to-supplier returning movement and another one related to the forwarding of the replacement packaging from the supplier to the customer. Within the context of exiting the distribution channel there fall events entailing exiting the channel of good distribution of marketed packaging.

Events causing the exiting of a packaging marketed into the distribution system are also the media reclassification owing to transformation into free sample and the medium invalidation for export, for which the transmission modes have been described within the context of the distribution process.

To meet explanation and support needs the system envisages an electronic mailbox, through which it is possible to formulate one's requests of information and explanation on system actuation aspects.

A Help Desk service is provided for specific support needs in the use of the system functionalities, and generally about technical, functional and operativeness aspects. Also any error or malfunctioning should be reported to the Desk.

In the utmost compliance with the management of safety products (banknote standard) the media, onto which the ID codes are affixed, are produced according to the needs of the individual products to be inlet in the system. The system makes use of all known technologies on safety media matters, thereby ranging from paper media to fabric ones; from plastics to metal. Also for coding, all known systems may be adopted, from the mere bar code to sophisticated microchips, or to DNA.

Without prejudice to the preceding indications, according to which all operations will take place through the peripheral units, which assure data transmission safety, concerning data transmission the following observations hold true for each data typology:

### Product Safety Codes.

The relevant element of the system is that the code meets important identification standards:
Country of production;
Producer;
Packaging type;
Packaging serial number.

Media codes are generated by a single Central Data Bank, so that there may immediately be checked that no replicated or incidentally alike coding be present;

### Assignment of Safety Media to Producers.

The Firm entrusted with safety system production receives from Management and Monitoring Centre the codes to be assigned to the various safety media. Once prepared, the media are sent to the producer of the technological products or of the consumer goods, upon checking the related data with the Central Data Bank, which definitively records them and makes them available to the system;

### Stolen or Lost Media Codes.

In case part or all of the produced media were stolen or lost, the producer of the same is bound to report them to the Management and Monitoring Centre. The latter shall enter these numbers into a special ‘black list’, inhibiting their circulation into the system;

### Reception of Producers' Safety Media.

Producer is also bound to report to Central Data Bank the data related to the media that have been taken charge of by the producer of the same;

### Codes Used on Produced Packaging.

Always the producer shall take care that codes related to media used in assembly with produced packaging are transmitted (by this transmission it is generated the storehouse of products provided with safety medium and awaiting marketing);

Codes of Products Stolen or Lost from Warehouses of the Producer of Goods to be Marketed.

In case part or all of the products with safety medium were stolen or lost, the producer of the same is bound to report them to the Central Data Bank;

### Codes of Packaging Inlet in Primary Distribution by the Producer.

The producer, by transmitting the data to the Central Data Bank, releases (writes down) identified and coded products to the storehouse entrusted with distribution;

### Codes of Packaging Received by the Various Primary Distributors.

The storehouse receiving the products takes charge of them, transmitting the data to the Central Data Bank, where it is performed a checking with what has been reported by the producer;

Codes of Products Stolen or Lost from Primary Distributor Warehouses.
In case part or all of the products with safety medium were stolen or lost, the primary producer of the same is bound to report them to the Central Data Bank;

### Codes of Packaging Sold to Intermediate Distributors.

The codes of packaging released by the storehouse as sent to the intermediate or final distributor, are transmitted to the Central Data Bank; the invention is capable of assuring to the producer the confirmation, even for administration purposes, of occurred consignment of products to the purchaser;

### Codes of Packaging Received by the Various Intermediate Distributors.

Upon receiving the packaging, the intermediate distributor takes care to transmit the related codes to the Central Data Bank, which compares them with storehouse transmission;

Codes of Products Stolen or Lost from Intermediate Distributor Warehouses.

In case part or all of the products with safety medium were stolen or lost, the intermediate distributor of the same is bound to report them to the Central Data Bank;

### Codes of Packaging Sold to Final Distributors.

Upon sending products to a retailer, the producer, as well as the primary or intermediate distributor, report to the Central Data Bank the data related to the codes of the products, as releasing (writing down) procedure;

### Codes of Packaging Received by the Various Final Distributors.

Upon receiving the goods, the retailer reports product codes to the Central Data Bank, which in turn checks them with supplier's declarations;

Codes of Products Stolen or Lost from Final Distributor Warehouses.

In case part or all of the products with safety medium were stolen or lost, the final distributor of the same is bound to report them to the Central Data Bank;

### Codes of Packaging Sold by the Final Distributor.

The retailer takes care to send to the Central Data Bank all codes of packaging sold or assigned for disposal as waste; failure to optically read and transmit product ID code does not activate producer's warranty, relieving the same producer of any responsibility. Therefore, the consumer shall take care of requiring the correct carrying out of the procedure that will be expressly quoted on the product packaging, near to the code;

### Codes of Packaging Conveyed to a Disposal Centre.

The producer, the primary, the intermediate and the final distributor should also transmit to the Central Data Bank all codes related to products not anymore intended for sale, or that they cannot sell anymore, and which are forwarded to destruction as waste, indicating the code of the disposal centre;

### Codes of Packaging Taken Charge and Disposed of by an Authorized Disposal Centre.

Upon receiving the waste, the disposal centre takes care to transmit to the Central Data Bank the codes of the products withdrawn and then disposed of according to the laws in force.

The present invention has been hereto described with reference to a preferred embodiment thereof. It is understood that other embodiments might exist, all falling within the concept of the same invention, and all comprised within the protective scope of the claims hereinafter.

1. A method for integral traceability and tracking of a plurality of products from their being inletted into a production and/or distribution cycle to their exiting the same cycle, through any movements thereof, comprising:
providing a Management and Monitoring Centre equipped with a Central Data Bank, capable of generating and storing univocal identifying (ID) codes to be associated with technological products and consumer goods, said ID codes being an identifying instrument of any single packaging of the product itself;
storing on said Central Data Bank the ID codes and the information related to each movement in the distribution cycle;
for each storing stage, automatically checking the consistency of the data stored on the Central Data Bank, performing checks on the stored ID codes; and,
producing an automatic alert condition signaling whenever said consistency checking yields anomalous results,
wherein said movements comprise at least one movement causing each product to exit the distribution cycle.

2. The method according to claim 1, wherein each data transmission to/from the Central Data Bank occurs through peripheral units located at peripheral sites of users of the method.

3. The method according to claim 2, wherein the Central Data Bank and said peripheral units communicate through a proprietary-type data transmission protocol.

4. The method according to claim 1, further comprising
invalidating the ID code t of a product that exits the distribution cycle, and
storing such ID code into a list of invalidated codes that cannot be used anymore.

5. The method according to claim 4, wherein said performing checks on the stored ID codes comprises comparing the stored ID codes with ID codes already stored in the list of invalidated codes.

6. The method according to claim 1, wherein said producing the automatic alert condition occurs when a stored ID code matches no previously generated code.

7. The method according to claim 5, wherein said producing the automatic alert condition occurs when the stored ID code matches a code already stored in the list of invalidated codes.

8. The method according to claim 1, further comprising
providing, for each of said products, a physical medium to be definitively associated therewith, said medium bearing said ID code.

9. A system for integral traceability and tracking of a plurality of products from their being inletted into a production and/or distribution cycle to their exiting the same cycle, through any movements thereof, comprising:
a Management and Monitoring Centre, adapted to superintend operation of the system and generate, for each product to be inlet into the distribution cycle, a corresponding ID code to be univocally associated thereto;
a Certifying Body, adapted to validate and certify said generated ID codes and their association with corresponding products;
a Central Data Bank, adapted to store data related to said products;
means for storing on said Central Data Bank data related to each movement of said products in the distribution cycle, said data comprising ID codes; and
means for checking the consistency of the data stored in the Central Data Bank, performing one or more checks on the stored ID codes,
wherein said movements comprise at least one movement causing each product to exit the distribution cycle.

10. The system according to claim 9, further comprising one or more peripheral units, located at respective system users' sites, said peripheral units being assigned to data transmission to/from the Central Data Bank.

11. The system according to claim 10, wherein the Central Data Bank and said peripheral units communicate through a proprietary-type data transmission protocol.

12. The system according to claim 9, further comprising means for invalidating a the ID code of a product exiting the production chain, and storing such ID code into a list of invalidated codes that cannot be used anymore.

13. The system according to claim 12, comprising means for comparing said stored ID code with ID codes already stored in the list of invalidated codes.

14. The system according to claim 9, further comprising means for signaling an alert condition, said alert condition occurring when the stored ID code matches a code already stored in the list of invalidated codes.

15. The system according to claim 13, further comprising means for signaling an alert condition, said alert condition occurring when the stored ID code matches a code already stored in the list of invalidated codes.

16. The system according to claim 9, further comprising, for each of said products, a corresponding physical medium to be definitively associated therewith, said medium bearing said ID code.
